(19) United States
(12) Patent Application Publication
(10) Pub. No.: US 2025/0086287 A1
(43) Pub. Date: Mar. 13, 2025

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Jun KANAI, Inagi Tokyo (JP); Tatsuya UEHARA, Kawasaki Kanagawa (JP); Hayeong SHIN, Yokohama Kanagawa (JP); Daiki ISHIHARA, Yokohama Kanagawa (JP); Toshiyuki KITO, Kodaira Tokyo (JP)

(73) Assignee: KABUSHIKI KAISHA TOSHIBA, Tokyo (JP)

(21) Appl. No.: 18/648,521

(22) Filed: Apr. 29, 2024

(30) Foreign Application Priority Data
Sep. 12, 2023 (JP) 2023-147352

(51) Int. Cl. G06F 21/57

(52) U.S. Cl. CPC G06F 21/577; G06F 2221/034

(57) ABSTRACT

According to one embodiment, an information processing device includes one or more hardware processors configured to function as a generation unit, an identification unit, and a vulnerability risk level calculation unit. The generation unit generates dependence information including an execution user of a first evaluation target and a dependence relationship representing being in a dependence relationship with the first evaluation target and access authority information of a resource. The identification unit identifies a resource accessible by the first evaluation target based on the execution user and the access authority information. The vulnerability risk level calculation unit calculates a vulnerability risk level indicating a risk level of each vulnerability from the resource accessible by the first evaluation target and one or more pieces of vulnerability information.

### CROSS-REFERENCE TO RELATED APPLICATIONS

This application is based upon and claims the benefit of priority from Japanese Patent Application No. 2023-147352, filed on Sep. 12, 2023; the entire contents of which are incorporated herein by reference.

### FIELD

Embodiments described herein relate generally to an information processing device, an information processing method, and a computer program product.

### BACKGROUND

These evaluation indexes do not consider a method of using fragile software, resources accessible from software, and the like. On the other hand, attack simulation technologies such as Breach and Attack Simulation (BAS) can be used for vulnerability evaluation in units of a system. However, these simulation technologies do not consider software implementation (dependence relationship) in a device and are based on the premise that the entire device is affected if there is vulnerability, and in practice, the risk may be overestimated.

In the related art, it is difficult to evaluate the risk of vulnerability with higher accuracy at lower calculation cost.

### BRIEF DESCRIPTION OF THE DRAWINGS

FIG. 1 is a diagram illustrating an example of a functional configuration of an information processing device according to an embodiment;

FIG. 2 is a diagram illustrating an example of a dependence information DB according to the embodiment;

FIG. 3 is a diagram illustrating an example of an ACL DB according to the embodiment;

FIG. 4 is a diagram illustrating an example of an asset importance level information DB according to the embodiment;

FIG. 5 is a flowchart illustrating an example of a generation flow of dependence information and an ACL according to the embodiment;

FIG. 6 is a flowchart illustrating an example of a calculation flow of a device risk according to the embodiment;

FIG. 7 is a diagram illustrating an example of a dependence information DB according to a modification of the embodiment;

FIG. 8 is a diagram illustrating an example of an ACL DB according to the modification of the embodiment;

FIG. 9 is a diagram illustrating an example of an asset importance level information DB according to the modification of the embodiment; and

FIG. 10 is a diagram illustrating an example of a hardware configuration of an information processing device according to the embodiment.

### DETAILED DESCRIPTION

An information processing device according to an embodiment includes one or more hardware processors configured to function as a generation unit, an identification unit, and a vulnerability risk level calculation unit. The generation unit is configured to generate dependence information including an execution user of a first evaluation target and a dependence relationship representing being in a dependence relationship with the first evaluation target, and access authority information of a resource. The identification unit is configured to identify a resource accessible by the first evaluation target based on the execution user and the access authority information. The vulnerability risk level calculation unit is configured to calculate a vulnerability risk level indicating a risk level of each vulnerability from the resource accessible by the first evaluation target and one or more pieces of vulnerability information. Hereinafter, embodiments of an information processing device, an information processing method, and a computer program product are described in detail with reference to the accompanying drawings.

The existing vulnerability evaluation index and attack simulation technology do not necessarily represent a risk when the vulnerability is left as a device or do not consider software implementation in the device, and thus cannot correctly evaluate the risk in some cases. In addition, when it is required to acquire a data flow at the time of risk evaluation, the calculation cost is high.

In the following embodiment, an information processing device that increases accuracy of risk calculation by enabling correct estimation of an influence on a device in a system at a lower calculation cost is described. With the information processing device according to the embodiment, it is possible to more appropriately determine measurement method against a risk, a measurement timing, and the like.

### Example of Functional Configuration

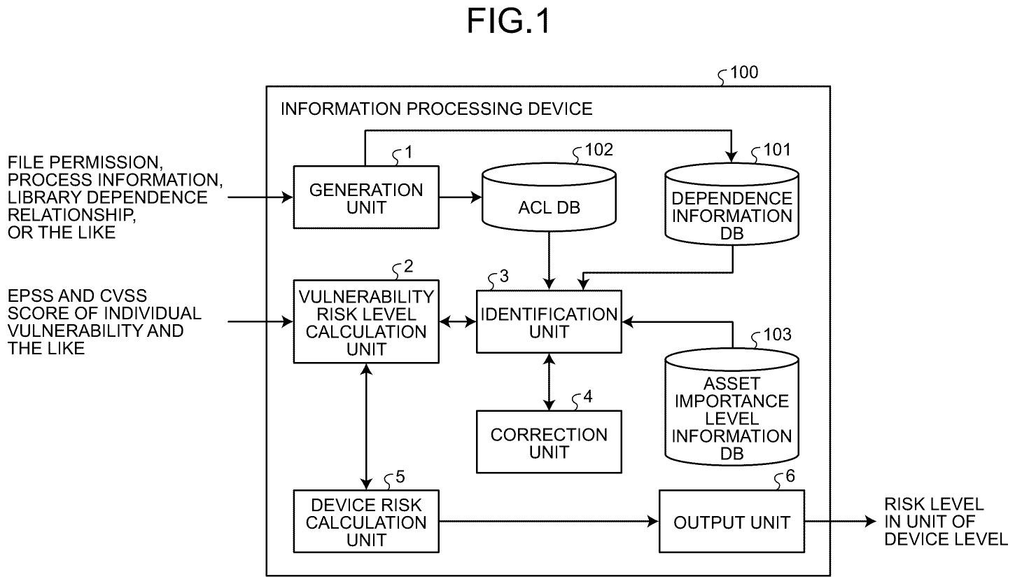

FIG. 1 is a diagram illustrating an example of a functional configuration of an information processing device 100 according to an embodiment. The information processing device 100 according to the embodiment includes a generation unit 1, a vulnerability risk level calculation unit 2, an identification unit 3, a correction unit 4, a device risk calculation unit 5, and an output unit 6. In addition, the information processing device 100 according to the embodiment stores a dependence information DB 101, an access control list (ACL) DB 102, and an asset importance level information DB 103.

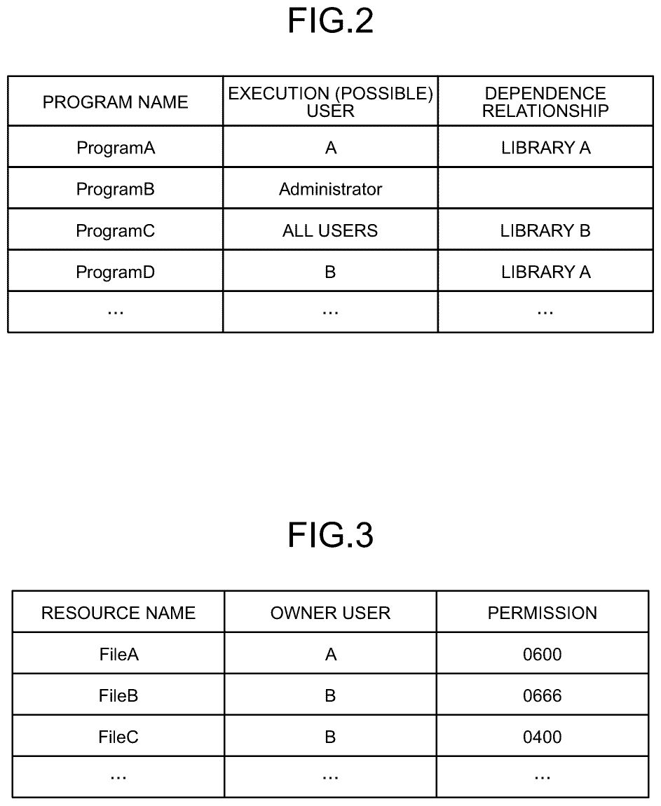

When receiving information used to generate dependence information and the ACL, the generation unit 1 generates the dependence information and the ACL, stores the generated dependence information in the dependence information DB 101 illustrated in FIG. 2, and stores the generated ACL in the ACL DB 102 illustrated in FIG. 3. The information used to generate the dependence information and the ACL is, for example, file permissions, process information, library dependence relationship, and the like.

FIG. 2 is a diagram illustrating an example of the dependence information DB 101 according to the embodiment. The dependence information DB 101 according to the embodiment stores data including a program name, an execution (possible) user, and a dependence relationship. The program name is a name of the program. The execution (possible) user indicates a user who can execute the program.

The dependence relationship is information indicating a library, a program, a service, and the like required for operation of the program, the service, and the like. As illustrated in FIG. 2, information on an execution (possible) user of the program may be associated with the dependence relationship. In the example of FIG. 2, when a library A (example of second program) is required for the operation of a program A (example of first program), the library A is included in the dependence information. In a case where the program A is executed by the user A as the execution user, the user A is associated with the dependence information.

Various forms can be considered as the resource information used for generating the dependence information. The resource information is information such as a file, hardware, and a program. For example, the resource information is process information acquired from a running device. Further, for example, the resource information is information of a library dependence relationship acquired by analyzing an execution file or the like.

The process information includes library information read by an operating program, another program communicating with the operating program, information on a user executing the operating program, and the like.

Further, when the execution file is analyzed by the generation unit 1, for example, load information of a library included in a header of a binary file may be analyzed. Further, for example, the library information required for executing the execution file may be analyzed with a program by a method such as decompiling. Since the library may depend on another library, the library information is desirably analyzed recursively.

Since the execution (possible) user is often indistinguishable from the content of the file, there is a method of identifying a user who can execute the file from the owner user of the execution file and the permission. For example, in a case where the owner of the execution file is the user A and the user who can execute the corresponding file with the permission is limited to only the owner, the execution (possible) user is only the user A. Even if the owner is the user A, when all the users can execute the file, execution (possible) users are all the users.

Referring back to FIG. 1, the generation unit 1 generates an ACL (an example of access authority information) from the accessible resource information and stores the ACL in the ACL DB 102 illustrated in FIG. 3 described below.

Various forms can also be considered for the

accessible resource information. For example, there is a method of using permission information as an input. The generation unit 1 stores a user who owns a resource and a permission for the resource in the ACL DB 102.

FIG. 3 is a diagram illustrating an example of the ACL DB 102 according to the embodiment. The ACL DB 102 of the embodiment stores data including a resource name, an owner user, and a permission. FIG. 3 is an example of an access control list based on a permission of a Unix (registered trademark)-based OS. The resource name is a name of a resource. The owner user indicates a user who owns the resource. The permission indicates a permission of a resource represented by an octal number.

For example, FileA in the first line is owned by the user A, and the permission is 0600, that is, indicates that reading and writing can be performed only by the user A who is the owner of the file. Furthermore, for example, as for FileB in the second line, the owner user is B, and the permission is 0666, that is, indicates that not only the user B but also all users can read and write.

Referring back to FIG. 1, when receiving the vulnerability information, the vulnerability risk level calculation unit 2 requests the identification unit 3 to identify a range of resources accessible by a program having a vulnerability or a program using a library. The vulnerability information is, for example, EPSS and CVSS scores of individual vulnerabilities. Then, the vulnerability risk level calculation unit 2 acquires information indicating asset importance level of the resource from the identification unit 3 and calculates the vulnerability risk level indicating the risk level for each item of vulnerability.

The asset importance level includes at least one of confidentiality importance level of the resource, safety importance level of the resource, and availability importance level of the resource.

For example, a method such as s CVSS environmental evaluation criteria is used as a vulnerability risk level calculation method.

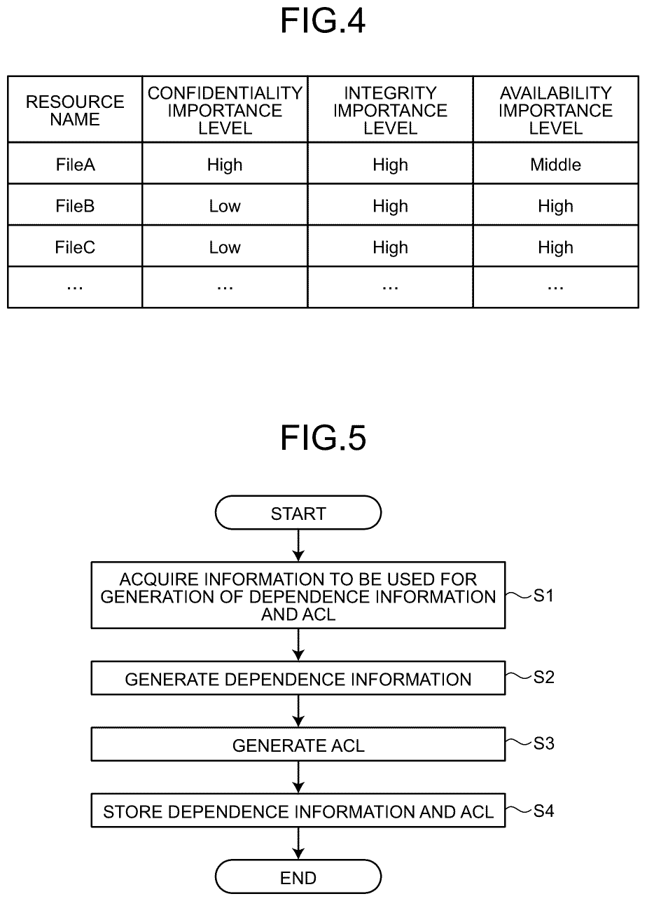

FIG. 4 is a diagram illustrating an example of the asset importance level information DB 103 according to the embodiment. The asset importance level information DB 103 of the embodiment stores data including a resource name, confidentiality importance level, integrity importance level, and availability importance level.

Taking the CVSS environmental evaluation criteria as an example, in a case where only FileA is included in the accessible range, the confidentiality importance level, the integrity importance level, and the availability importance level are High, High, and Middle, respectively.

In a case where FileA and FileB are included in the accessible range, a value with a higher importance level is selected, and the confidentiality importance level, the integrity importance level, and the availability importance level are High, High, and High, respectively.

The vulnerability risk level calculation unit 2 sets, as the vulnerability risk level, environment values calculated by setting values of the confidentiality importance level, the integrity importance level, and the availability importance level as CR, IR, and AR in CVSS, respectively.

Note that the environmental evaluation criteria indicate a technical attack risk but do not necessarily indicate a possibility of attack. In practice, the attack possibility varies depending on the presence of an attack verification code (a program for checking whether the software has a specific vulnerability), the presence or absence of an attack campaign, and the like. For this reason, when calculating the vulnerability risk level, the vulnerability risk level calculation unit 2 may multiply the environmental value or the like calculated by the environmental evaluation criteria by a parameter indicating the attack possibility and calculate the vulnerability risk level such that the higher the attack possibility, the higher the vulnerability risk level. Examples of the index to be used include a CVSS current value and an EPSS.

That is, the vulnerability risk level calculation unit 2 may determine the attack possibility of the specific vulnerability based on whether at least one of the first program and the second program on which the first program depends has a verification code for checking whether there is a specific vulnerability or whether there is an attack campaign against the specific vulnerability. As such, the vulnerability risk level of the specific vulnerability may be calculated further based on the attack possibility of the specific vulnerability.

Referring back to FIG. 1, when receiving the vulnerability information from the vulnerability risk level calculation unit 2, the identification unit 3 identifies a range of resources accessible by a program having a vulnerability (first program) or a program using a library (second program). For example, the generation unit 1 analyzes the first program to identify the second program and generates the dependence information including the identified second program. When the vulnerability information of the second program is included in the one or more pieces of vulnerability information, the identification unit 3 identifies a resource accessible by the first program.

In addition, the identification unit 3 reads the asset importance level information (see FIG. 4 described above) of the identified resource from the asset importance level information DB 103.

Specifically, for example, when there is a vulnerability in the program A, since the execution user is A from FIG. 2, the identification unit 3 acquires a resource accessible by the user A from FIG. 3. From the example of FIG. 3, FileA of which the owner user is A, and FileB that can be read and written by anyone correspond as accessible resources. Further, the identification unit 3 acquires the confidentiality importance level, the integrity importance level, and the availability importance level for the accessible resources from the asset importance level information of FIG. 4 and returns the confidentiality importance level, the integrity importance level, and the availability importance level to the vulnerability risk level calculation unit 2.

Note that the identification unit 3 may identify a possible operation for a resource from an ACL (an example of access authority information) in more detail. Then, the vulnerability risk level calculation unit 2 may calculate the vulnerability risk level further based on the possible operations for the resource.

Specifically, the identification unit 3 may analyze the permissions of FIG. 3 in detail and recalculate the confidentiality importance level, the integrity importance level, and the availability importance level with the granularity of read, write, and execution. For example, for FileC, integrity is important in FIG. 4, but FileC is a file that can only be read with reference to the permission in FIG. 3, and it is difficult to falsify. Therefore, when the vulnerability is found in the program B accessible to FileC, the identification unit 3 may change the integrity importance level from high to low and return the integrity importance level to the vulnerability risk level calculation unit 2.

In addition, for example, when the vulnerability is found in the library A, the programs using the library A from the dependence information DB 101 in FIG. 2 are ProgramA and ProgramD. In this case, since the execution (possible) user of ProgramA is A, the accessible resource of ProgramA is FileA from the owner user and the permission information in the ACL DB 102 in FIG. 3. Also, since the execution (possible) user of ProgramD is B, the accessible resource of ProgramD is FileB and FileC from the owner user and the permission information in the ACL DB 102 in FIG. 3.

That is, the accessible ranges when the vulnerability exists in the library A are FileA, FileB, and FileC.

When the one or more pieces of vulnerability information include a vulnerability that enables at least one of the first program and the second program on which the first program depends to be operated by another user, the correction unit 4 makes a correction to add a resource accessible by the other user to the range of resources accessible by the first program.

Specifically, the correction unit 4 corrects the accessible range by recalculating a resource that can be accessed with a promoted authority in a case of being able to access the resource beyond the initially accessible range of the program in which the vulnerability such as the authority promotion vulnerability exists. For example, when there is a vulnerability in the program B, it is possible to initially access FileB and FileC. However, in a vulnerability in which the authority can be changed to a privileged user or the user A, it is also possible to access FileA. Furthermore, in a case of a kernel vulnerability that enables operation in the privileged mode, the correction unit 4 can access all resources and thus corrects the accessible range to all of FileA, FileB, and FileC.

When a plurality of vulnerability risk levels are calculated for the evaluation target device, the device risk calculation unit 5 calculates a device risk indicating the vulnerability risk level in the device based on the plurality of vulnerability risk levels. That is, when there are a plurality of vulnerabilities, the device risk calculation unit 5 calculates a risk level at the device level (risk in the device) from the vulnerability risk level (risk in the vulnerability alone) calculated by the vulnerability risk level calculation unit 2. An example of calculation of the risk level at the device level is, for example, as follows.

The risk of vulnerability i normalized in the range of 0 to 1.0 (0: lowest risk, 1.0: highest risk) is defined as R(i). For the vulnerability that has already been corrected, the vulnerability is not included in the population, or R(i)=0 is set. Various calculation methods can be considered for a risk Rall in the entire device obtained by totaling the risks R(0) to R(n−1) at this time, and, for example, the risk Rall is calculated by Equation (1).

$$\begin{matrix}Rall = 1 - \prod ( 1 - R ( i ) ) & ( i = 0 , … , n - 1 )\end{matrix} \qquad ( 1 )$$

Equation (1) above is an example of calculation of a risk in the entire device, in which R(i) is regarded as a probability of being attacked by the vulnerability alone, and a risk of being attacked by the entire vulnerability is calculated as a probability of appearing in an independent event.

In addition to Equation (1) above, the risk in the entire device may be simply obtained by adding R(i) as in Equation (2) as follows.

$$\begin{matrix}Rall = \sum R ( i ) & ( i = 0 , … , n - 1 )\end{matrix} \qquad ( 2 )$$

Furthermore, for example, as in Equation (3) as follows, the maximum value of the individual vulnerability risk may be regarded as the risk in the entire device.

$$\begin{matrix}Rall = max ( R ( i ) ) & ( i = 0 , … , n - 1 )\end{matrix} \qquad ( 3 )$$

The output unit 6 outputs presentation information (for example, an evaluation result including at least one of a vulnerability risk level and a device risk) based on the device risk calculated by the device risk calculation unit 5 by at least one of display information and voice.

With respect to the presentation timing of the information based on the device risk, for example, the output unit 6 may present the Rall each time the vulnerability is found or may present the current risk value Rall at regular intervals. In addition, the output unit 6 may make a notification when R(i) is a predetermined threshold value or more.

Furthermore, as the information presented by the output unit 6, not only the Rall (device risk) but also the risk R(i) (vulnerability risk level) of each vulnerability may be presented, or an accessible range serving as a calculation basis, vector information for CVSS calculation, or the like may be presented.

FIG. 5 is a diagram illustrating an example of a generation flow of dependence information and an ACL according to the embodiment. First, the generation unit 1 acquires information used for generating dependence information and an ACL (for example, file permission, process information, library dependence relationship, and the like) (step S1).

Next, the generation unit 1 generates the dependence information and the ACL from the information acquired in step S1 (steps S2 and S3). Next, the generation unit 1 stores the dependence information generated in step S2 in the dependence information DB 101 and stores the ACL generated in step S3 in the ACL DB 102 (step S4).

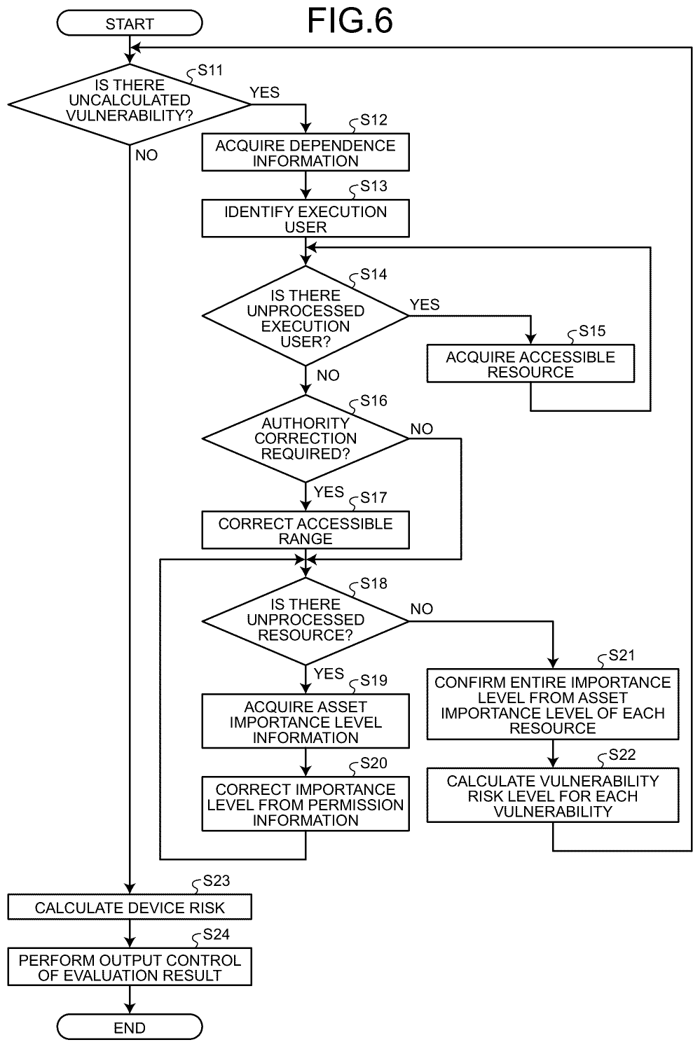

FIG. 6 is a diagram illustrating an example of a calculation flow of a device risk (vulnerability risk level in a device) according to the embodiment. To perform device-level vulnerability calculation in response to elapse of a certain period of time or finding of a new vulnerability, the vulnerability risk level calculation unit 2 first checks whether there is an uncalculated vulnerability in order to calculate a risk of each vulnerability (step S11).

In a case where there is an uncalculated vulnerability (step S11: Yes), the identification unit 3 acquires dependence information having a dependence relationship with the program, the library, or the like in which the vulnerability is found from the dependence information DB 101 (step S12). In step S12, a list of programs or the like of which the operation depends on the program, the library, and the like in which the vulnerability is found is identified.

Next, the identification unit 3 further identifies an execution user of the program from the dependence information (step S13). Since the resource accessible by the execution user changes, the following processing is executed for each execution user.

The identification unit 3 first determines whether there is an unprocessed execution user (step S14). When there is an unprocessed execution user (step S14: Yes), the identification unit 3 acquires a resource accessible by the execution user from the ACL (step S15).

Meanwhile, when there is no unprocessed execution user (step S14: No), the correction unit 4 determines whether it is required to correct the authority according to the characteristic of the vulnerability (step S16). The standard for the authority correction is, for example, whether the vulnerability is a vulnerability of a program, a service, or the like that operates in the kernel mode. In addition, for example, the standard for the authority correction is whether the vulnerability is a vulnerability in which authority can be promoted.

If the authority is required to be corrected (step S16: Yes), the correction unit 4 corrects the accessible range (step S17). Specifically, in the case of the kernel vulnerability, the vulnerability in which the administrator authority can be acquired, or the like, the correction unit 4 corrects the accessible range such that all resources can be accessed. Furthermore, for example, in a case of a vulnerability that can intrude into a program executed by another user, the correction unit 4 performs correction to add a resource accessible from the other user to the accessible range.

After the accessible range is corrected, or when the authority is not required to be corrected, the importance level of the asset is acquired for each resource determined to be accessible. Specifically, the identification unit 3 determines whether there is an unprocessed resource (step S18). When there is an unprocessed resource (step S18: Yes), the identification unit 3 obtains asset importance level information of the resource from the asset importance level information DB 103 illustrated in FIG. 4 (step S19). Furthermore, the correction unit 4 may correct the asset importance level information from the permission of the resource (step S20).

Steps S19 and S20 are repeated until there is no unprocessed resource. When there is no unprocessed resource (step S18: No), the vulnerability risk level calculation unit 2 confirms the importance level of the entire resource that can be affected by the vulnerability from the asset importance level of each resource (step S21). Furthermore, the vulnerability risk level calculation unit 2 calculates the vulnerability risk level for each vulnerability from the importance level of the entire resource, information on the vulnerability, the possibility of attack, and the like (step S22).

As a calculation method of step S22, for example, a method of calculating characteristics of vulnerability such as the CVSS environmental evaluation criteria and a method of multiplying the CVSS current value or the risk level in consideration of the attack possibility such as EPSS can be considered, but the calculation method is not limited to these methods.

Then, when the uncalculated vulnerability disappears (step S11: No), the device risk calculation unit 5 calculates a device risk indicating a risk level in consideration of the entire vulnerability in the device (step S23). As a calculation method of step S23, Equations (1), (2), and (3) described above and the like are used.

Finally, the output unit 6 determines whether to output the output information and the evaluation result presented by the output information according to the vulnerability risk level calculated in step S22, the device risk calculated in step S23, and the like and performs output control of the evaluation result (step S24).

As described above, in the information processing device 100 according to the embodiment, the generation unit 1 generates the dependence information including the execution user of the first evaluation target (the program in the embodiment) and the dependence relationship representing being in the dependence relationship with the first evaluation target, and the access authority information (an ACL in the embodiment) of the resource. The identification unit 3 identifies a resource accessible by the first evaluation target based on the execution user information and the access authority information. Then, the vulnerability risk level calculation unit 2 calculates a vulnerability risk level indicating a risk level for each vulnerability from the resource accessible by the first evaluation target and one or more pieces of vulnerability information.

As a result, with the information processing device 100 of the embodiment, the risk of vulnerability can be evaluated with higher accuracy at lower calculation cost. Specifically, the influence of the vulnerability on the resource is clarified in the device, and the influence can be calculated with higher accuracy than the attack simulation technology in the related art and the like. In addition, in the present embodiment, it is not required to acquire a data flow or the like, and it is possible to clarify the influence on the attack that hits the vulnerability by static information acquired statically or dynamic information acquired in a short time even if the dynamic information is dynamically acquired. Specifically, not only the vulnerability risk level as a single vulnerability but also the influence at the device level (the device risk described above) in a case where there are a plurality of vulnerabilities can be clarified. Therefore, the timing of patch application or the like for the vulnerability can be determined more appropriately.

### Modification of Embodiment

Next, a modification of the embodiment is described. In the description of the modification, the description similar to that of the embodiment is omitted, and portions different from those of the embodiment are described. In the above-described embodiment, a method is described in which the evaluation target is a program, and the risk as a device is determined from the vulnerability risk level for the program. In the modification, a case where the evaluation target is a first service implemented by one or more programs, and the dependence relationship is a second service on which the first service depends is described.

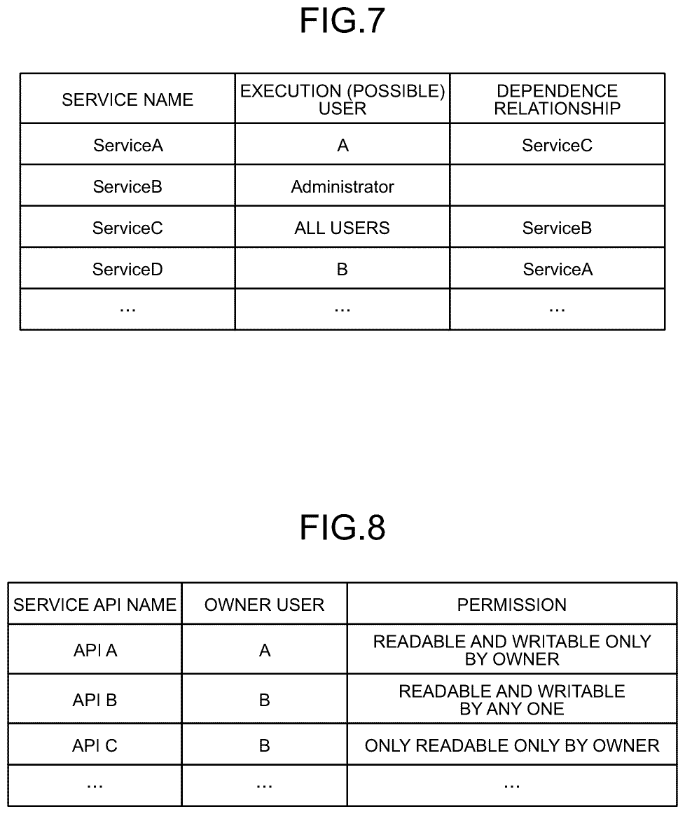

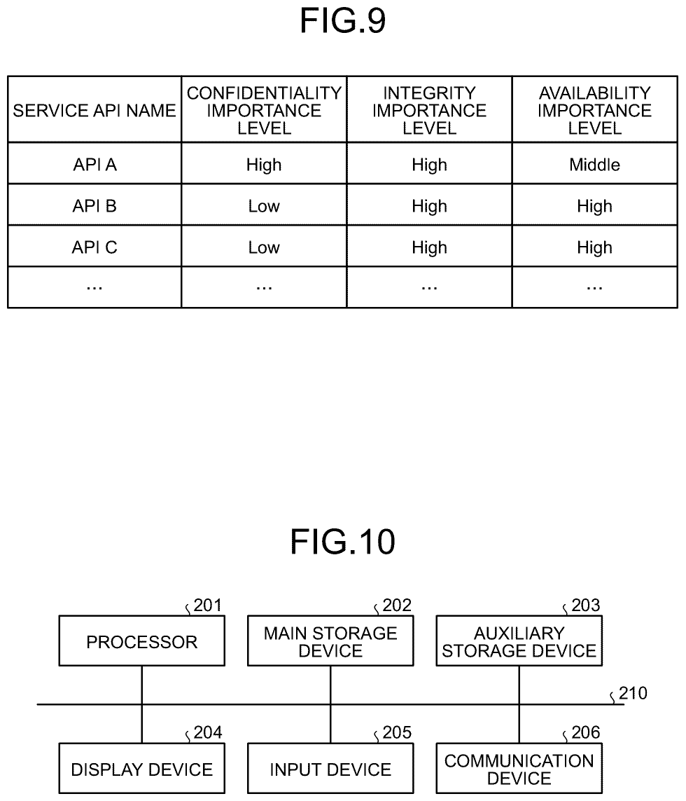

Specifically, in the modification, the program (software) dependence relationship is replaced with dependence information between services as illustrated in FIG. 7. In the modification, the access control list is replaced with access authorization information of a service API of an inter-device call as illustrated in FIG. 8. In the modification, the importance of the asset is replaced with the importance level at a service API level or the like as illustrated in FIG. 9.

As a result, the above-described embodiment can also be applied to risk calculation as a system including a plurality of services (a plurality of devices).

According to the modification, when the risk level at the system level is calculated, the service risk is calculated in consideration of the calculation result for each service (device), whereby the risk level can be calculated with higher accuracy from the vulnerability information.

Lastly, an example of a hardware configuration of the information processing device 100 according to the embodiment is described. The information processing device 100 according to the embodiment can be implemented, for example, by using any computer device as basic hardware. Example of Hardware Configuration

FIG. 10 is a diagram illustrating an example of a hardware configuration of the information processing device 100 of the embodiment. The information processing device 100 of the embodiment includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected to each other via a bus 210.

Note that the information processing device 100 may not include a part of the above configurations. For example, when the information processing device 100 can use an input function and a display function of an external device, the display device 204 and the input device 205 may not be provided in the information processing device 100.

The processor 201 executes a program read from the auxiliary storage device 203 to the main storage device 202. The main storage device 202 is a memory such as a ROM and a RAM. The auxiliary storage device 203 is a hard disk drive (HDD), a memory card, or the like.

The display device 204 is, for example, a liquid crystal display or the like. The input device 205 is an interface for operating the information processing device 100. Note that the display device 204 and the input device 205 may be implemented by a touch panel or the like having a display function and an input function. The communication device 206 is an interface for communicating with other devices.

For example, the program executed by the information processing device 100 is a file in an installable format or an executable format, is recorded in a computer-readable storage medium such as a memory card, a hard disk, a CD-RW, a CD-ROM, a CD-R, a DVD-RAM, and a DVD-R, and is provided as a computer program product.

Furthermore, for example, programs to be executed by the information processing device 100 may be configured to be stored on a computer connected to a network such as the Internet and be provided by being downloaded via the network.

Furthermore, for example, the program executed by the information processing device 100 may be configured to be provided via a network such as the Internet without being downloaded. Specifically, the process may be executed, for example, by an application service provider (ASP) type cloud service.

In addition, for example, the programs of the information processing device 100 may be configured to be provided by being incorporated in a ROM or the like in advance.

The program executed by the information

processing device 100 has a module configuration including functions that can be implemented by the program among the functional configurations described above. As actual hardware, the corresponding functions are implemented by the processor 201 reading a program from a storage medium and executing the program, and the functional blocks are loaded on the main storage device 202. That is, the functional blocks are generated on the main storage device 202.

Note that some or all of the functions described above may not be implemented by software but may be implemented by hardware such as an integrated circuit (IC).

In addition, each function may be implemented by using the plurality of processors 201, and in this case, the processors 201 each may implement one of the functions or may implement two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to function as:
a generation unit configured to generate dependence information including an execution user of a first evaluation target and a dependence relationship representing being in a dependence relationship with the first evaluation target, and access authority information of a resource;
an identification unit configured to identify a resource accessible by the first evaluation target based on the execution user and the access authority information; and
a vulnerability risk level calculation unit configured to calculate a vulnerability risk level indicating a risk level of each vulnerability from the resource accessible by the first evaluation target and one or more pieces of vulnerability information.

2. The information processing device according to claim 1, wherein
the first evaluation target is a first program, and
the dependence relationship includes information indicating a second program on which the first program depends.

3. The information processing device according to claim 2, wherein
the generation unit analyzes the first program to identify the second program and generates dependence information including the identified second program, and
the identification unit identifies the resource accessible by the first program when the one or more pieces of vulnerability information include vulnerability information of the second program.

4. The information processing device according to claim 1, wherein
the vulnerability risk level calculation unit calculates the vulnerability risk level further based on asset importance level of the resource.

5. The information processing device according to claim 4, wherein
the asset importance level includes at least one of confidentiality importance level of the resource, safety importance level of the resource, and availability importance level of the resource.

6. The information processing device according to claim 5, wherein
the identification unit identifies a possible operation for the resource from the access authority information, and the vulnerability risk level calculation unit calculates the vulnerability risk level further based on the possible operation for the resource.

7. The information processing device according to claim 2, wherein
the vulnerability risk level calculation unit
determines an attack possibility of a specific vulnerability based on whether at least one of the first program and the second program includes a verification code as a program for checking whether the specific vulnerability is present, or whether an attack campaign against the specific vulnerability is present, and
calculates the vulnerability risk level of the specific vulnerability further based on the attack possibility of the specific vulnerability.

8. The information processing device according to claim 2, wherein the one or more hardware processors are configured to further function as:
a correction unit configured to make a correction to add a resource accessible by another user to a range of resources accessible by the first program when the one or more pieces of vulnerability information include a vulnerability that enables at least one of the first program and the second program to be operated by the another user.

9. The information processing device according to claim 8, wherein
the correction unit corrects a range of resources accessible by the first program to all resources when the one or more pieces of vulnerability information include a kernel vulnerability that enables at least one of the first program and the second program to operate in a privileged mode.

10. The information processing device according to claim 1, wherein the one or more hardware processors are configured to further function as:
a device risk calculation unit configured to calculate a device risk indicating a vulnerability risk level in a device to be evaluated based on a plurality of vulnerability risk levels when the plurality of vulnerability risk levels are calculated for the device.

11. The information processing device according to claim 10, wherein the one or more hardware processors are configured to further function as:
an output unit configured to output an evaluation result including at least one of the vulnerability risk level and the device risk by at least one of display information and voice.

12. The information processing device according to claim 1, wherein
the first evaluation target is a first service implemented by one or more programs, and
the dependence relationship includes information indicating a second service on which the first service depends.

13. An information processing method implemented by an information processing device, the method comprising:
generating dependence information including an execution user of a first evaluation target and a dependence relationship representing being in a dependence relationship with the first evaluation target, and accessing authority information of a resource;
identifying a resource accessible by the first evaluation target based on the execution user and the access authority information; and
calculating a vulnerability risk level indicating a risk level of each vulnerability from the resource accessible by the first evaluation target and one or more pieces of vulnerability information.

14. A computer program product having a non-transitory computer readable medium including programmed instructions stored thereon, wherein the instructions, when executed by a computer, cause the computer to function as:
a generation unit configured to generate dependence information including an execution user of a first evaluation target and a dependence relationship representing being in a dependence relationship with the first evaluation target, and access authority information of a resource;
an identification unit configured to identify a resource accessible by the first evaluation target based on the execution user and the access authority information; and
a vulnerability risk level calculation unit configured to calculate a vulnerability risk level indicating a risk level of each vulnerability from the resource accessible by the first evaluation target and one or more pieces of vulnerability information.
